(19) United States
(12) Patent Application Publication
(10) Pub. No.: US 2010/0051178 A1
(43) Pub. Date: Mar. 4, 2010

(54) METHOD OF MANUFACTURING THIN FILM DEVICE

(75) Inventors: Hwan-Soo LEE, Seoul (KR); Yongsoo OH, Seongnam (KR)

Correspondence Address: MCDERMOTT WILL & EMERY LLP, 18191 VON KARMAN AVE., SUITE 500, IRVINE, CA, 92612-7108, US

(73) Assignee: SAMSUNG ELECTRO-MECHANICS CO., LTD., Suwon (KR)

(21) Appl. No.: 12/467,149

(22) Filed: May 15, 2009

(30) Foreign Application Priority Data
Sep. 2, 2008 (KR) 10-2008-0086469

(51) Int. Cl. B32B 37/02

(52) U.S. Cl. 156/152

(57) ABSTRACT

A method of manufacturing a thin film device according to an aspect of the invention may include: forming a sacrificial layer on a first substrate; forming a thin film on the sacrificial layer, the thin film being an object of transfer; temporarily bonding a support structure to the thin film; removing the sacrificial layer to separate the thin film from the first substrate; bonding the thin film, temporarily bonded to the support structure, to a second substrate; and separating the support structure from the thin film.

### CROSS-REFERENCE TO RELATED APPLICATIONS

This application claims the priority of Korean Patent Application No. 2008-0086469 filed on Sep. 2, 2008, in the Korean Intellectual Property Office, the disclosure of which is incorporated herein by reference.

### BACKGROUND OF THE INVENTION

1. Field of the Invention

The present invention relates to a method of manufacturing a thin film device, and more particularly, to a method of manufacturing a thin film device using a thin-film transfer process that can be used as a technique for manufacturing a flexible substrate.

2. Description of the Related Art

In general, a thin-film transfer technique has been widely used in thin film devices, such as thin film transistors (TFTs), electronic devices, and optical devices including organic EL devices.

The thin-film transfer technique generally refers to a technique that forms a predetermined thin film on a preliminary substrate and then transfers the thin film onto a permanent substrate to thereby manufacture a desired thin film device. This thin-film transfer technique can be of great use when conditions of a substrate used to form a film are different from those of a substrate used in a thin film device.

For example, even though a semiconductor thin-film forming technique requires a relatively high-temperature process, if a substrate used in a thin film device has low thermal resistance or a low softening point and a low melting point, the thin-film transfer technique can be very advantageously applied. Particularly, the thin-film transfer technique can be advantageously applied to flexible thin-film devices.

In the related art, since a flexible device needs to have flexibility, an organic substrate formed of, such as a polymer, is used, and an organic thin film serving as a functional unit is disposed on the top of the organic substrate. However, since it is difficult to ensure high performance by using the functional unit formed of the organic thin film, an inorganic material, such as polysilicon (poly-Si) or an oxide thin film, is used to form a functional unit of the flexible device. Here, since it is difficult to directly apply the high-temperature semiconductor film forming technique to the flexible substrate formed of the organic material, the thin-film transfer technique that transfers a thin film formed of an inorganic material, such as a semiconductor, onto another preliminary substrate is used.

However, a surface that is separated from the preliminary substrate is provided as an upper surface of the thin film transferred onto the permanent substrate, and remnants of a sacrificial layer remain on the upper surface. Therefore, a process of removing the remnants of the sacrificial layer is further required in order to prevent it having an adverse effect on the thin film device.

When a thin film pattern is required, a patterning process is generally performed after transferring the thin film onto the permanent substrate. If the patterning process has been previously performed, the permanent substrate, used as a support substrate, may be damaged by laser irradiation when removing the sacrificial layer in order to separate the permanent substrate from the preliminary substrate.

However, when the patterning process is performed after the thin film has been transferred onto the permanent substrate, thermal-chemical damage to the permanent substrate caused by the patterning process needs to be considered.

### SUMMARY OF THE INVENTION

An aspect of the present invention provides a method of manufacturing a thin film device that simplifies a process and improves the reliability of the device by changing a surface to be bonded to a permanent substrate by using a temporary support structure.

According to an aspect of the present invention, there is provided a method of manufacturing a thin film device, the method including: forming a sacrificial layer on a first substrate; forming a thin film on the sacrificial layer, the thin film being an object of transfer; temporarily bonding a support structure to the thin film; removing the sacrificial layer to separate the thin film from the first substrate; bonding the thin film, temporarily bonded to the support structure, to a second substrate; and separating the support structure from the thin film.

The first substrate may be a transparent substrate.

The removing the sacrificial layer may include irradiating a laser beam onto the sacrificial layer through the transparent substrate.

The sacrificial layer may include ITO, ZnO, or SnO₂.

The temporarily bonding the support structure to the thin film may include pressing the support structure against the thin film such that a surface of the thin film makes tight contact with a surface of the support structure.

The support structure may include a polydimethylsiloxane (PDMS)-based polymer or a silicon rubber-based polymer.

The bonding the thin film to the second substrate may include bonding an adhesive layer to the second substrate and bonding the thin film to the second substrate using the adhesive layer.

The method may further include patterning the thin film to form a thin film pattern between the forming the film and the temporarily bonding the thin film.

The thin film pattern may include a functional portion pattern performing a particular function and a support portion pattern connected to the functional portion pattern and having a larger area than the functional portion pattern, wherein the method further may include removing the support portion pattern other than the functional portion pattern after the separating the support structure.

The second substrate may be a flexible substrate.

The thin film may be a semiconductor thin film.

The thin film may be a metal thin film.

The thin film may be a thin film for a display device.

The method may further include forming a protective layer on the second substrate to which the thin film is bonded after the separating the support structure.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1D are cross-sectional views illustrating a process of forming a lamination including a transfer object in a method of manufacturing a thin film according to an exemplary embodiment of the present invention;

FIGS. 2A and 2B are cross-sectional views illustrating a transferral process in a method of manufacturing a thin film device according to the exemplary embodiment illustrated in FIGS. 1A through 1D;

FIGS. 3A through 3D are cross-sectional views illustrating a method of transferring a thin film pattern according to another exemplary embodiment of the present invention; and

FIG. 4 is a perspective view illustrating an example of a thin film pattern that can be used in a method of manufacturing a thin film device (flexible device) according to a specific exemplary embodiment of the present invention.

### DETAILED DESCRIPTION OF THE PREFERRED EMBODIMENT

Exemplary embodiments of the present invention will now be described in detail with reference to the accompanying drawings.

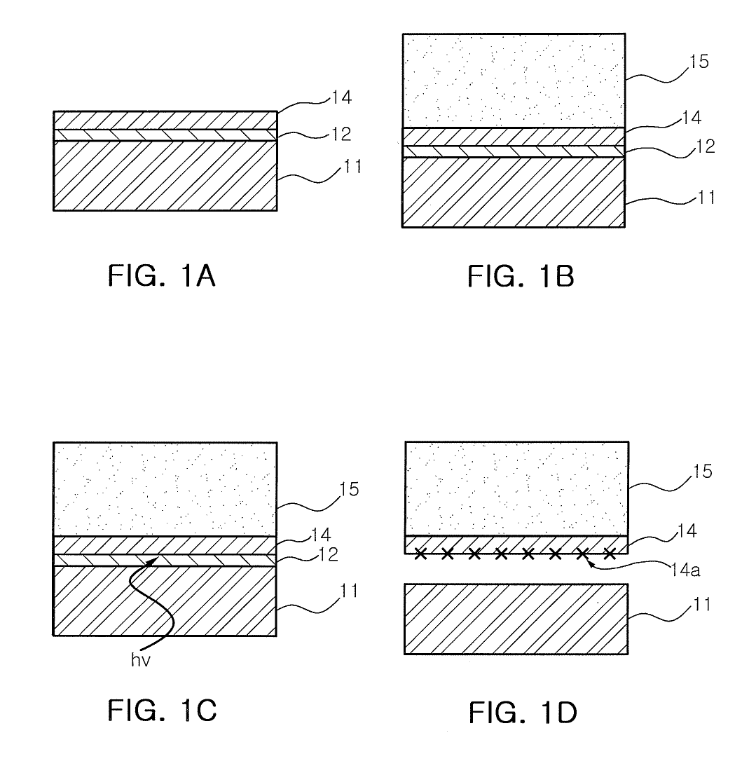

FIGS. 1A through 1D are cross-sectional views illustrating a process of forming a lamination including a transfer object in a method of manufacturing a thin film device according to an exemplary embodiment of the invention.

As shown in FIG. 1A, a sacrificial layer 12 and a thin film 14 to be transferred are sequentially formed on a first substrate 11.

A thin film 14 is formed on the first substrate 11. The first substrate 11 is formed of a material having durability in a high-temperature film forming process of growing the desired thin film 14. In general, a laser lift off (LLO) method is used for the separation of the thin film 14 to be transferred. This is also considered when selecting the material forming the first substrate 11.

That is, the first substrate 11 may be formed of a material having a larger band gap energy than a band gap energy corresponding to a wavelength of the laser beam such that the laser beam can be transmitted through the first substrate 11. Preferably, a transparent substrate may be used as the first substrate 11. However, the invention is not limited thereto. The first substrate 11 may be formed of any one of sapphire, quartz, glass, magnesium oxide (MgO), a lanthanum aluminate (LaAlO3), fused silica, and zirconia.

The “sacrificial layer 12” is a layer formed of a material that can be decomposed by a laser to be used in the thin film removal process. In a subsequent process, a laser (hυ in FIG. 1C) may be transmitted through the first substrate 11 to decompose the sacrificial layer 12.

In order to selectively remove the sacrificial layer 12, a focus control method may be used to focus the laser energy onto the sacrificial layer 12. However, it is desirable that the materials of the first substrate 11 and the sacrificial layer 12 are appropriately selected according to the wavelength of the laser beam to be used.

The sacrificial layer 12 may include a transparent conductive oxide layer having an energy band gap enabling the absorption of the wavelength of the laser to be used. However, the invention is not limited thereto. The sacrificial layer 12 may be formed of a material such as ITO, ZnO or SnO₂. A thin film that absorbs the wavelength of the laser to be used and can be easily melted, that is, a thin film that contains another low-melting point material, for example, a polymer, In, or Pb, may be used.

The thin film 14 has a structure used to form a functional unit of a desired thin film device. The thin film 14 may be formed of an inorganic material, such as a semiconductor or polysilicon, or a metal. The thin film 14, serving as the functional unit, may be patterned, which will be described below. The thin film 14 may be formed using a known film forming technique, such as sputtering, evaporation, and CVD.

Then, as shown in FIG. 1B, a support structure 15 is temporarily bonded to the film 14.

The support structure 15 makes tight contact with the surface of the thin film 14 so that the support structure 15 and the thin film 14 are temporarily bonded to each other. The support structure 15 is a temporary support body that is used before the thin film 14 is transferred to a second substrate (permanent substrate).

The term “temporary bonding”, used throughout this specification, can be understood as a bonding state in which the bonding strength between the thin film 14 and the support structure 15 is maintained enough to support and handle the thin film 14 at least until the transferral process is performed, but is weaker than a bonding strength between the thin film 14 and the second substrate to which the thin film 14 will be transferred.

The “temporary bonding” process refers to a bonding process that is performed neither by the use of an additional unit, such as an adhesive, nor by fusion welding using a high-temperature heat treatment process.

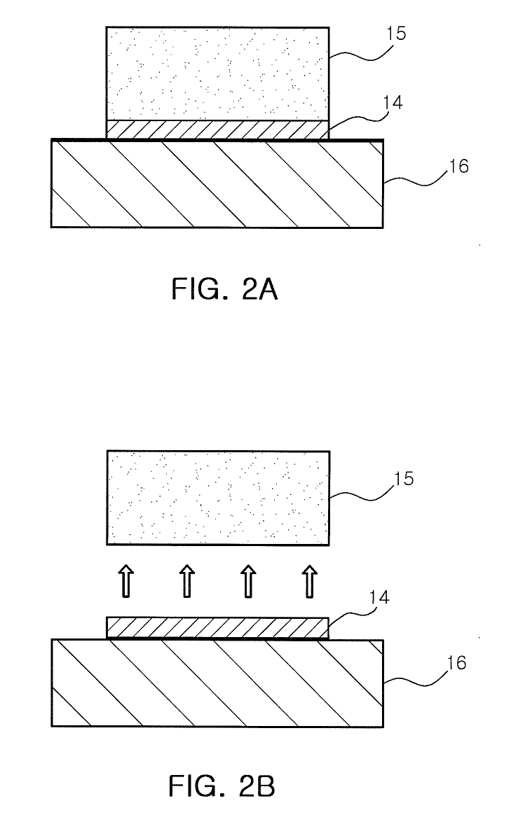

Preferably, the temporary bonding process may be performed by making tight contact between smooth surfaces of the thin film 14 and the support structure 15 so that the thin film 14 and the support structure 15 are temporarily bonded to each other by the van der Waals' force. The temporary bonding process can be sufficiently performed under low pressure at room temperature. Therefore, after the thin film 14 is transferred onto the second substrate, the support structure can be easily separated from the thin film 14. Further, even after the support structure 15 is separated from the thin film 14, a clean surface of the thin film 14 from which the support structure 15 is separated can be ensured. This will be described below with reference to FIGS. 2A and 2B.

In order to more easily perform temporary bonding by the van der Waals' force, the support structure 15 may be preferably formed of, for example, a polymer material such as a polydimethylsiloxane (PDMS)-based polymer and a silicon rubber-based polymer. However, the invention is not limited thereto. The support structure 15 may be formed of a material that allows the above-described temporary bonding by the similar interface action.

Then, the sacrificial layer 12 is removed so that the thin film 14 is separated from the first substrate 11. Various known removing processes, such as chemical etching, can be considered. However, in this embodiment, the laser lift off (LLO) method may preferably be used.

First, as shown in FIG. 1C, the sacrificial layer 12 is removed by irradiating the laser hυ. As described above, the irradiation of the laser hυ used to remove the sacrificial layer 12 is performed by irradiating the bottom surface of the first substrate 11, which is the above-described transparent substrate, with light from the laser hυ. The sacrificial layer 12 having a band gap to absorb the wavelength of the laser light may be thermally decomposed and removed.

Then, when the sacrificial layer 12 is removed by the thermal decomposition, as shown in FIG. 1D, the thin film 14 is separated from the first substrate 11 by the support structure 15. However, it is difficult to expect the complete removal of the sacrificial layer 12, and the remnants of the sacrificial layer 12 remain on a separation surface 14a of the thin film 14.

However, in this embodiment, the separated thin film 14 is not directly transferred onto the second substrate but is temporarily bonded to the support structure 15, which is a temporary support structure. The separation surface 14a on which the remnants of the sacrificial layer remain can be provided as a surface contacting the second substrate.

This will be described in more detail with reference to FIGS. 2A and 2B. FIGS. 2A and 2B are views illustrating a transferral process in a method of manufacturing a thin film device according to an exemplary embodiment of the invention. That is, a process of manufacturing a thin film device using the lamination (14 and 15), shown in FIG. 1D, is shown.

As shown in FIG. 2A, the thin film 14 that is temporarily bonded to the support structure 15 is bonded to a second substrate 16.

The term “second substrate” or “permanent substrate”, used throughout the specification, refers to a substrate onto a thin film is transferred, and constitutes the thin film device.

In this process, the bonding strength between the thin film 14 and the second substrate 16 bonded to each other is higher than that between the support structure 15 and the thin film 14 temporarily bonded to each other. To this end, like this embodiment, an adhesive layer 17 may be additionally used to bond the thin film 14 and the second substrate 16 to each other.

This process can be performed by spreading an adhesive material over the second substrate 16 and bonding the thin film thereto. Here, the adhesive material includes a precursor having a greater bonding strength than that between the support structure 15 and the thin film 14.

Then, as shown in FIG. 2B, the support structure 15 is separated from the thin film 14. As described above, since the thin film 14 and the second substrate 16 have a higher bonding strength because of the adhesive layer 17, the support structure 15 can be easily separated from the thin film 14 because they have a relatively low bonding strength.

As described above, when the thin film 14 and the support structure 15 are temporarily bonded to each other by the van der Waals' force, the separation surface of the thin film 14 can be very clean even after the support structure 15 is separated therefrom.

The thin-film transfer technique according to this embodiment can be used for various thin film devices. Specifically, even when a semiconductor film forming technique requires a relatively high temperature process, if a substrate used in the device has low thermal resistance or a low softening point and a low melting point, the thin-film transfer technique can be very advantageously used. Particularly, the thin-film transfer technique can be advantageously applied to flexible thin film devices.

Here, the second substrate may be a flexible substrate that is formed of a polymer, and the thin film may be a semiconductor thin film or a metal thin film. Further, the thin film may be formed of amorphous silicon or polysilicon for a display device.

A thin film that is generally transferred in actual applications is provided as a thin film pattern. As described above, in the related art, after the thin film is transferred onto the permanent substrate (second substrate), a patterning process is then performed. That is, when a thin film pattern is previously formed before transferring the thin film, the laser lift off (LLO) method is performed together with the transferral process in the related art. Therefore, the laser may be irradiated onto the permanent substrate through a space between the thin film pattern to thereby cause damage.

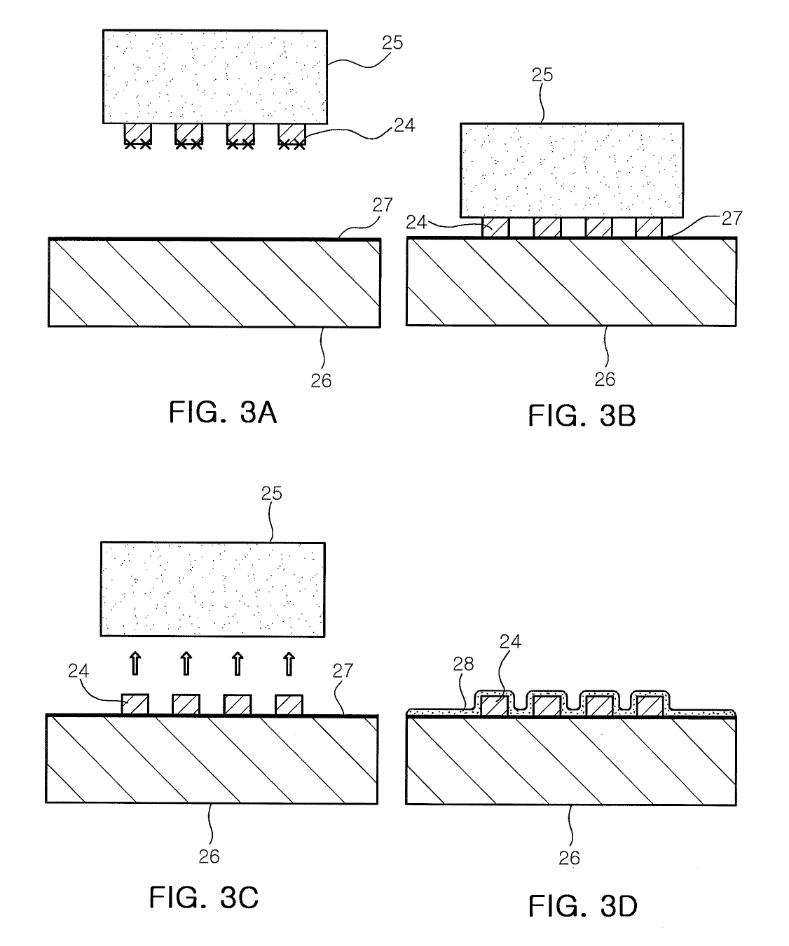

However, since the support structure, which is a temporary support structure, is used in this embodiment, this problem can be solved. The method of transferring a thin film pattern will be described with reference to FIGS. 3A through 3D.

As shown in FIG. 3A, a thin film pattern 24 is temporarily bonded to a support structure 25, and a second substrate 26 has an adhesive layer 27 coated to an upper surface thereof. The thin film pattern 24 is obtained by growing a thin film and a sacrificial layer at the same time on the first substrate, shown in FIG. 1A, and then patterning the thin film.

After this process, the thin film pattern 24 is obtained by removing the sacrificial layer using the laser lift off method while the thin film pattern 24 is temporarily bonded to the support structure 25. In this case, even when the laser beams may be irradiated towards the support structure 25 between the thin film pattern, in the support structure 25 can play its role without any problem.

Then, as shown in FIG. 3B, the thin film pattern 24 is bonded to the second substrate 26 using the adhesive layer 27.

Next, as shown in FIG. 3C, since the support structure 25 is separated from the thin film pattern 24. In this case, since the thin film pattern 24 and the second substrate 26 have a high bonding strength by the adhesive layer 27, the support structure 25 can be easily separated from the thin film pattern 24 since the thin film pattern 24 and the support structure 25 have a relatively low bonding strength. Furthermore, as described above, if the thin film pattern 24 and the support structure 25 are temporarily bonded to each other by the van der Waals, force as described above, a separation surface of the thin film pattern 24 can be very clean even after the support structure 25 is separated therefrom.

In this embodiment, as shown in FIG. 3D, a protective layer 28 is additionally formed to protect the thin film pattern 24 formed on the second substrate 26. The protective layer 28 may be provided by performing a known coating process, such as spin coating, using appropriate insulating resin.

The thin film pattern 24 or the thin film 14, illustrated in the above embodiment, may be understood as a functional unit that serves a particular function of a thin film device. When the functional unit is patterned and has a small width, since a sufficient bonding area is not provided, it may prove difficult to perform temporary bonding by simply making contact between the thin film and a support structure.

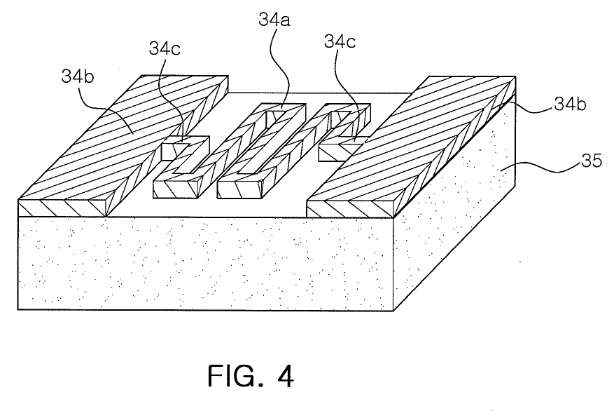

In order to solve this problem, as shown in FIG. 4, a support portion pattern may be additionally formed to ensure a bonding area during the patterning process.

Referring to FIG. 4, one example of a thin film pattern that can be used in a method of manufacturing a thin film device (flexible device) according to a specific embodiment of the invention is illustrated. A thin film pattern 34 is temporarily bonded to the support structure and is separated from the first substrate.

The thin film pattern 34, shown in FIG. 4, includes a functional portion pattern 34a that performs a particular function and a support portion pattern 34b. Here, the support portion pattern 34b is connected to the functional portion pattern 34a by a connection portion pattern 34c, and has a larger area than the functional portion pattern 34a.

Since the functional portion pattern 34a does not have a sufficient bonding area, it is difficult to make contact between the functional portion pattern 34a and the support structure 35 by temporary bonding. However, the functional portion pattern 34a can be temporarily bonded to a support structure 35 through the support portion pattern 34b that is located on both sides and has a relatively large area. The support portion pattern 34b and the connection portion pattern 34c except for the functional portion pattern 34a may be transferred onto a second substrate and then removed.

As set forth above, according to exemplary embodiments of the invention, a process of removing remnants of a sacrificial layer can be omitted by providing a separation surface of a thin film or a thin film pattern as a surface to be bonded to a permanent substrate, and problems caused by the remnants can be solved.

Further, a process of changing a bonding surface by using a support structure can be easily performed by the action at the material interface, such as the van der Waals' force, without using a separate adhesive layer, thereby simplifying the entire process.

Furthermore, the invention allows a process of patterning a thin film to be performed on a preliminary substrate, and can be effectively used as a process of manufacturing a flexible device.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a thin film device, the method comprising:
forming a sacrificial layer on a first substrate;
forming a thin film on the sacrificial layer, the thin film being an object of transfer;
temporarily bonding a support structure to the thin film;
removing the sacrificial layer to separate the thin film from the first substrate;
bonding the thin film, temporarily bonded to the support structure, to a second substrate; and
separating the support structure from the thin film.

2. The method of claim 1, wherein the first substrate is a transparent substrate.

3. The method of claim 2, wherein the removing the sacrificial layer comprises irradiating a laser beam onto the sacrificial layer through the transparent substrate.

4. The method of claim 3, wherein the sacrificial layer comprises ITO, ZnO, or SnO₂.

5. The method of claim 1, wherein the temporarily bonding the support structure to the thin film comprises pressing the support structure against the thin film such that a surface of the thin film makes tight contact with a surface of the support structure.

6. The method of claim 5, wherein the support structure comprises a polydimethylsiloxane (PDMS)-based polymer or a silicon rubber-based polymer.

7. The method of claim 1, wherein the bonding the thin film to the second substrate comprises bonding an adhesive layer to the second substrate and bonding the thin film to the second substrate using the adhesive layer.

8. The method of claim 1, further comprising patterning the thin film to form a thin film pattern between the forming the film and the temporarily bonding the thin film.

9. The method of claim 8, wherein the thin film pattern comprises a functional portion pattern performing a particular function and a support portion pattern connected to the functional portion pattern and having a larger area than the functional portion pattern,
wherein the method further comprises removing the support portion pattern other than the functional portion pattern after the separating the support structure.

10. The method of claim 1, where the second substrate is a flexible substrate.

11. The method of claim 1, wherein the thin film is a semiconductor thin film.

12. The method of claim 1, wherein the thin film is a metal thin film.

13. The method of claim 1, wherein the thin film is a thin film for a display device.

14. The method of claim 1, further comprising forming a protective layer on the second substrate to which the thin film is bonded after the separating the support structure.
